(19) United States
(12) Patent Application Publication
(10) Pub. No.: US 2015/0081811 A1
(43) Pub. Date: Mar. 19, 2015

(54) METHOD FOR PROVIDING MESSAGE TO MOBILE COMMUNICATION DEVICE

(71) Applicant: Quanta Computer Inc., Taoyuan Shien (TW)

(72) Inventors: Tien-Chin FANG, Taoyuan County (TW); Chen-Chung LEE, Nantou County (TW); Ping-Chi LAI, Taoyuan Shien (TW); Chia-Hung LIN, New Taipei City (TW); Ming-Jen CHEN, New Taipei City (TW); Ching-Wen LIN, Taoyuan Shien (TW); Ching-Yu TSAI, New Taipei City (TW)

(73) Assignee: QUANTA COMPUTER INC., Taoyuan Shien (TW)

(21) Appl. No.: 14/195,029

(22) Filed: Mar. 3, 2014

(30) Foreign Application Priority Data
Sep. 14, 2013 (TW) 102133405

(51) Int. Cl. H04L 12/58

(52) U.S. Cl. CPC H04L 51/04
USPC 709/206

(57) ABSTRACT

The present invention discloses a method for providing a message to a mobile communication device. The method includes the following steps: a dispatched message is received from a service-providing server through a message-dispatching server. The dispatched message includes identification information of at least one message receiver. Rule-operating and message-processing are performed to the dispatched message through the message-dispatching server after a fixed time period from a time at which the dispatched message is received. The rule-operated and message-processed dispatched message is displayed on a display unit of a mobile communication device through the message-dispatching server. The mobile communication device logs in with the identification information of the message receiver.

### RELATED APPLICATIONS

This application claims priority to Taiwan Application Serial Number 102133405, filed Sep. 14, 2013, which is herein incorporated by reference.

### BACKGROUND

1. Field of Invention

The present invention relates to a method for providing a message. More particularly, the present invention relates to a method for providing a message to a mobile communication device.

2. Description of Related Art

Through wireless network technology, a network without the use of wires forms interconnections between wireless network devices for sharing information. The wireless network technology includes CDMA 2000, General Packet Radio Service (GPRS), Global System for Mobile Communications (GSM), Universal Mobile Telecommunications System (UMTS), Wi-Fi, Worldwide Interoperability for Microwave Access (WiMAX) etc. Concerning the mobility, the wireless network devices equipped with the above-mentioned technology are developed and become very popular.

In that most enterprises have their own information service systems, it would cost time and money to adapt the current systems to provide messages for mobile communication devices.

Moreover, the enterprises mostly may use emails or Short Message Service (SMS) to transmit messages as information notification mechanism. However, emails cannot notify users immediately, and SMS needs extra costs and may be incompatible with the current systems.

### SUMMARY

According to one embodiment of this invention, a method for providing a message to a mobile communication device is disclosed to utilize a message-dispatching server to process messages for the mobile communication device to display. The method for providing a message to a mobile communication device includes the following steps: a dispatched message is received from a service-providing server through a message-dispatching server. Wherein, the dispatched message includes identification information of at least one message receiver. Rule-operating and message-processing are performed to the dispatched message through the message-dispatching server after a fixed time period from a time at which the dispatched message is received. The rule-operated and message-processed dispatched message is displayed on a display unit of a mobile communication device through the message-dispatching server. Wherein, the mobile communication device logs in utilizing the identification information of the message receiver.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flow diagram of a method for providing a message to a mobile communication device according to one embodiment of this invention; and

FIG. 2 is an embodiment of a block diagram of a system applying the method for providing a message to a mobile communication device.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

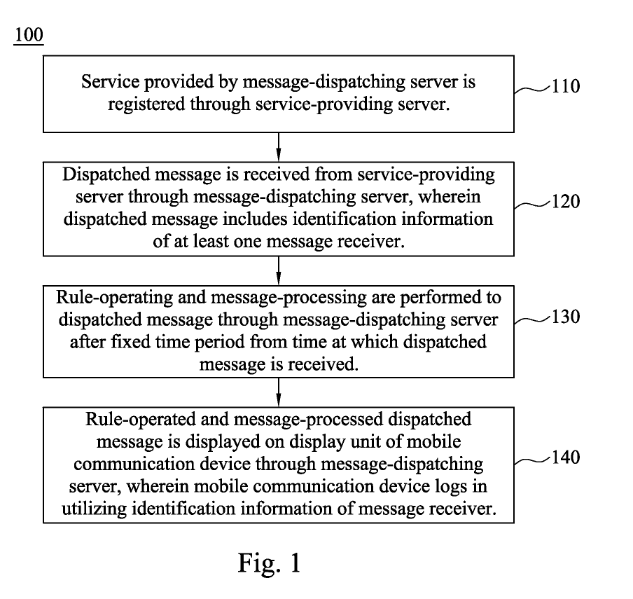

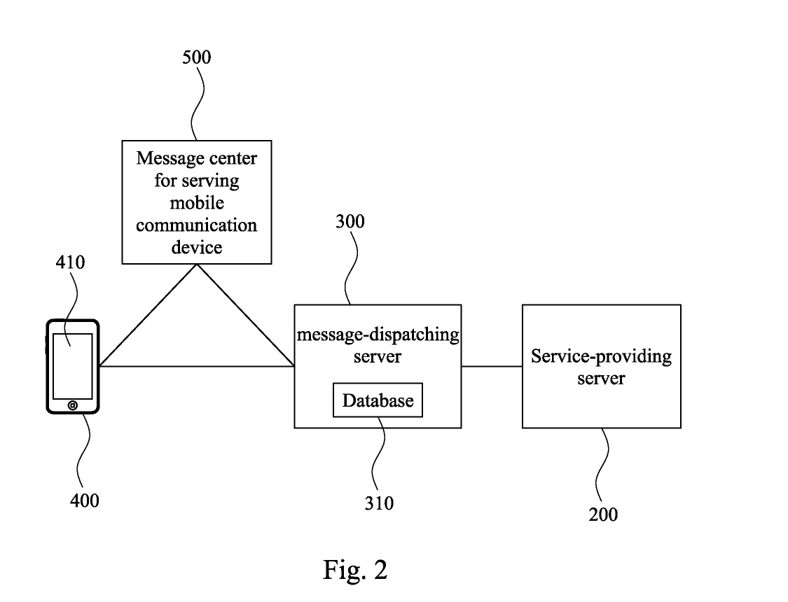

FIG. 1 is a flow diagram of a method for providing a message to a mobile communication device according to one embodiment of this invention. In the method for providing a message to a mobile communication device, a message-dispatching server is utilized to process messages for the mobile communication device to display. The method for providing a message to a mobile communication device may take the form of a computer program product (for example, an application (APP)) stored on a non-transitory computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs), digital versatile disc read only memories (DVD-ROMs), and Blu-ray Disc read only memories (BD-ROMs); magnetic storage devices such as hard disk drives (HDDs); and solid-state disks (SSDs). FIG. 2 is an embodiment of a block diagram of a system applying the method for providing a message to a mobile communication device.

Referring to both FIG. 1 and FIG. 2, the method 100 for providing a message to a mobile communication device includes the following steps:

At step 120, a dispatched message is received from a service-providing server 200 through a message-dispatching server 300. Wherein, the dispatched message includes identification information of at least one message receiver. The service-providing server 200 may be one single server or a combination of several servers, and the message-dispatching server 300 may also be one single server or a combination of several servers. In addition the service-providing server 200 may build a connection with the message-dispatching server 300 through a network or any other data communication interface for receiving the dispatched message (step 120).

Before receiving the dispatched message (step 120), a service provided by the message-dispatching server 300 may be registered through the service-providing server 200 (step 110). Then, the service-providing server 200 can transmit the message to be dispatched to the message-dispatching server 300 for being received at step 120. In addition, after the registration is performed (step 110), the message-dispatching server 300 may provide message frames as factors to provide a Restful API (application interface), which provides web services following Representational State Transfer (REST). Hence, in one embodiment of step 120, the message-dispatching server 300 can utilize message frames to receive the dispatched message from the service-providing server 200 through the Restful API. Therefore, in some scenario of this invention, the service-providing server 200 can transmit the messages to be dispatched to the message-dispatching server 300 by simply applying the message frames.

At step 130, after a fixed time period from a time at which the dispatched message is received, rule-operating and message-processing are performed to the dispatched message through the message-dispatching server 300. In other words, rule-operating and message-processing are triggered after waiting for the fixed time period. Therefore, the service-providing server 200 can still amend the message to be dispatched in the fixed time period, which can reduce the number for rule-operating and message-processing. In addition, if there is more than one message receiver, the message-dispatching server 300 may duplicate the rule-operated and message-processed dispatched message, and may embed identification information of the message receivers respectively into the duplicated messages to be displayed on each message receiver's device.

At step 140, the rule-operated and message-processed dispatched message is displayed on a display unit 410 of a mobile communication device 400 through the message-dispatching server 300. Wherein, the mobile communication device 400 logs in utilizing the identification information of the message receiver. In other words, the message receiver can log in with his/her identification information through a mobile communication device 400, such that the display unit 410 of the mobile communication device 400 can display the rule-operated and message-processed dispatched message. The mobile communication device 400 may be a smart phone, a notebook computer or any other electrical device with mobile communication ability and a display unit. Therefore, messages can be displayed on the mobile communication device 400 through the message-dispatching server 300 without developing different systems for different services.

In some embodiments of step 140, an application (APP) program can be installed on the mobile communication device 400 in advance. Wherein, the installed APP can drive the mobile communication device 400 to obtain the rule-operated and message-processed dispatched message from the message-dispatching server 300 according to the identification information of the message receiver for the display unit 410 to display. For example, the mobile communication device 400 may have an antenna and may drive the antenna to connect to a network utilizing Wi-Fi, a mobile communication network protocol (such as GSM, CDMA or 3G) or any other wireless network communication protocol. Hence, the mobile communication device 400 may connect to the message-dispatching server 300 through the network for obtaining the rule-operated and message-processed dispatched message. Therefore, the mobile communication device 400 can obtain and display the message dispatched from the service-providing server 200 by simply installing the APP.

In some other embodiments of step 140, the message-dispatching server 300 can utilize a PUSH technology to PUSH the rule-operated and message-processed dispatched message to the mobile communication device 400 for the display unit 410 to display. PUSH, or server PUSH, describes a style of Internet-based communication where the request for a given transaction is initiated by the publisher or central server. The message-dispatching server 300 can transmit the rule-operated and message-processed dispatched message to a message center 500 for serving the mobile communication device 400 for performing PUSH. The message center 500 may perform PUSH utilizing Apple Push Notification Service (APNS), Google Cloud Messaging (GCM) or any other PUSH service for the mobile communication device 400.

When the message-dispatching server 300 performs the rule-operating and message-processing (step 130), it may perform different processes to single-directional messages and bi-directional messages. In some embodiments of step 130, when the message-dispatching server 300 performs the rule-operating and determines that the dispatched message is a single-directional message, a reply option in the rule-operated and message-processed dispatched message may be disabled. When the dispatched message is a single-directional message, the service-providing server 200 may set a message-category column to a value representing a single-directional message and transmit it to the message-dispatching server 300. Hence, during performing the rule-operating, the message-dispatching server 300 may determine if the dispatched message is a single-directional message according to the value in the message-category column. Therefore, since the reply option of the rule-operated and message-processed dispatched message is disabled, unnecessary replies can be avoided. For example, when the content of the dispatched message is utilized for publishing information and no reply is needed, the service-providing server 200 can set the dispatched message as a single-directional message.

In some other embodiments of step 130, when the message-dispatching server 300 performs the rule-operating and determines that the dispatched message is a bi-directional message, several reply options in the rule-operated and message-processed dispatched message can be enabled for the display unit 410 of the mobile communication device 400 to display. When the dispatched message is a bi-directional message, the service-providing server 200 may set a message-category column to a value representing a bi-directional message and transmit it to the message-dispatching server 300. Hence, during performing the rule-operating, the message-dispatching server 300 may determine if the dispatched message is a bi-directional message according to the value in the message-category column. When the message-dispatching server 300 determines that the dispatched message is a bi-directional message, the message-dispatching server 300 may further analyze the value in the message-category column and enable the preset reply options corresponding to the value in the message-category column for the display unit 410 of the mobile communication device 400 to display.

Then, a user of the mobile communication device 400 can select one of the preset reply options. Hence, the mobile communication device 400 may generate a select signal correspondingly according to the user's selection to select one of the preset reply options. In some embodiments of this invention, the message-dispatching server 300 may receive the select signal from the mobile communication device 400. In subsequence, the message-dispatching server 300 may update a reply record belonging to the dispatched message in its database 310 according to the select signal.

In some other embodiments of this invention, the select signal can be transmitted to a preset application interface (API) of the service-providing server 200, such that the service-providing server 200 updates a reply record belonging to the dispatched message according to the select signal. The dispatched message may include connection information about connecting to the preset API of the service-providing server 200, such that the mobile communication device 400 can transmit the select signal through the connection.

In addition, the message-dispatching server 300 may analyze a content of the dispatched message to generate information about related software for opening the content of the dispatched message. For example, if the content of the dispatched message includes a network address, the message-dispatching server 300 may set a browser as the related software and generate the information about the browser. Then, the message-dispatching server 300 may embed the information about the related software (for example, the browser) into the rule-operated and message-processed dispatched message. When the mobile communication device receives the rule-operated and message-processed dispatched message, it can open the content of the dispatched message utilizing the related software (for example, the browser.)

Moreover, the dispatched message may further include information of required privilege. Hence, the message-dispatching server 300 may determine if privilege of the message receiver matches the information of the required privilege. When the message-dispatching server 300 determines that the privilege of the message receiver does not match the information of the required privilege, step 140 may not be performed, such that the rule-operated and message-processed dispatched message is not displayed on the display unit 410 of the mobile communication device 400. Therefore, only the user with sufficient privileges can read the dispatched message. In addition, only when the message-dispatching server 300 determines that the privilege of the message receiver matches the information of the required privilege, step 140 may be performed to display the rule-operated and message-processed dispatched message on the display unit 410 of the mobile communication device 400.

In the method 100 for providing a message to a mobile communication device, the message-dispatching server 300 may further determines if a service subscribed by the message receiver includes a service corresponding to the dispatched message. When the message-dispatching server 300 determines that a service subscribed by the message receiver does not include a service corresponding to the dispatched message, step 140 may not be performed, such that the rule-operated and message-processed dispatched message is not displayed on the display unit 410 of the mobile communication device 400. Therefore, the user may not receive messages, which he/she does not subscribe. In addition, only when the message-dispatching server 300 determines that a service subscribed by the message receiver includes a service corresponding to the dispatched message, step 140 may be performed to display the rule-operated and message-processed dispatched message on the display unit 410 of the mobile communication device 400.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for providing a message to a mobile communication device, comprising:
(a) receiving a dispatched message from a service-providing server through a message-dispatching server, wherein the dispatched message comprises identification information of at least one message receiver;
(b) performing rule-operating and message-processing to the dispatched message through the message-dispatching server after a fixed time period from a time at which the dispatched message is received; and
(c) displaying the rule-operated and message-processed dispatched message on a display unit of a mobile communication device through the message-dispatching server, wherein the mobile communication device logs in with the identification information of the message receiver.

2. The method for providing a message to a mobile communication device of claim 1, wherein an application (APP) is installed in the mobile communication device, and step (c) comprises:
utilizing the APP to drive the mobile communication device to obtain the rule-operated and message-processed dispatched message from the message-dispatching server according to the identification information of the message receiver.

3. The method for providing a message to a mobile communication device of claim 1, wherein step (c) comprises:
utilizing the message-dispatching server to push the rule-operated and message-processed dispatched message to the mobile communication device, such that the display unit of the mobile communication device displays the rule-operated and message-processed dispatched message.

4. The method for providing a message to a mobile communication device of claim 1, wherein step (b) comprises:
disabling a reply option in the rule-operated and message-processed dispatched message when the message-dispatching server performs the rule-operating and determines that the dispatched message is a single-directional message.

5. The method for providing a message to a mobile communication device of claim 1, wherein step (b) comprises:
enabling a plurality of reply options in the rule-operated and message-processed dispatched message when the message-dispatching server performs the rule-operating and determines that the dispatched message is a bi-directional message.

6. The method for providing a message to a mobile communication device of claim 5, further comprising:
receiving a select signal from the mobile communication device, wherein the select signal is utilized for selecting at least one of the reply options; and
updating a reply record belonging to the dispatched message in a database according to the select signal.

7. The method for providing a message to a mobile communication device of claim 5, further comprising:
generating a select signal through the mobile communication device, wherein the select signal is utilized for selecting at least one of the reply options; and
transmitting the select signal to a preset application interface (API) of the service-providing server, such that the service-providing server updates a reply record belonging to the dispatched message according to the select signal.

8. The method for providing a message to a mobile communication device of claim 1, further comprising:
analyzing a content of the dispatched message to generate information about related software for opening the content of the dispatched message; and
embedding the information about the related software into the rule-operated and message-processed dispatched message, such that the mobile communication device opens the content of the dispatched message utilizing the related software.

9. The method for providing a message to a mobile communication device of claim 1, wherein the dispatched message further comprises information of required privilege, and the method further comprises:
determining if privilege of the message receiver matches the information of the required privilege; and
performing step (c) when the privilege of the message receiver matches the information of the required privilege.

10. The method for providing a message to a mobile communication device of claim 1, further comprising:
determining if a service subscribed by the message receiver comprises a service corresponding to the dispatched message; and
performing step (c) when the service subscribed by the message receiver comprises the service corresponding to the dispatched message.
